(19) United States
(12) Patent Application Publication
(10) Pub. No.: US 2014/0033715 A1
(43) Pub. Date: Feb. 6, 2014

(54) MAIN STREAM TEMPERATURE CONTROL SYSTEM FOR LARGE BOILER

(71) Applicants: Zijun Ni, Shanxi (CN); Chanbao Zhang, Shanxi (CN); Qiugang Duan, Shanxi (CN); Bing Zhang, Shanxi (CN); Zhiqiang Long, Shanxi (CN); Xiaojun Ma, Shanxi (CN); Lihua Du, Shanxi (CN); Lihua Hao, Shanxi (CN); Yanwen Liu, Shanxi (CN); Zhiyu Ni, Shanxii (CN); Hong Yang, Shanxi (CN); Yansheng Du, Shanxi (CN)

(72) Inventors: Zijun Ni, Shanxi (CN); Chanbao Zhang, Shanxi (CN); Qiugang Duan, Shanxi (CN); Bing Zhang, Shanxi (CN); Zhiqiang Long, Shanxi (CN); Xiaojun Ma, Shanxi (CN); Lihua Du, Shanxi (CN); Lihua Hao, Shanxi (CN); Yanwen Liu, Shanxi (CN); Zhiyu Ni, Shanxii (CN); Hong Yang, Shanxi (CN); Yansheng Du, Shanxi (CN)

(73) Assignees: SHANXI ELECTRIC POWER RESEARCH INSTITUTE, Shanxi (CN); SHANXI ELECTRIC POWER COMPANY, Shanxi (CN)

(21) Appl. No.: 13/882,151

(22) PCT Filed: Aug. 29, 2011
(86) PCT No.: PCT/CN2011/001444

§ 371 Date: Apr. 26, 2013

(30) Foreign Application Priority Data
Apr. 29, 2011 (CN) 201110111016.6

(51) Int. Cl. F22B 35/00; G05B 11/36

(52) U.S. Cl. CPC F22B 35/00; G05B 11/36
USPC 60/667; 236/25 R

(57) ABSTRACT

A main stream temperature control system for a large boiler comprises a PID module, A/D converters (M2, M3, M4, and M5), D/A converters (M6 and M7), electrical water spray adjusting valves (AA101 and AA102) and main stream temperature sensors (T1, T2, T3, and T4) for the boiler. The system uses a function module (f (x)), a differential module, a division module, multiplication modules (F1 and F2), addition and subtraction modules (J1, J2, J3, and J4), set value modules (K1-K6), selection modules (N1 and N2), a time pulse module (S1) and small value comparison modules (Z1 and Z2) in a distributed control system, so as to construct a real-time online optimized circuit and form an independent automatic control system for dynamic tracking and stable control, thereby increasing the thermal economic index of the boiler, and achieving the objective of energy saving and emission reduction.

### BACKGROUND

1. Field

This invention relates to an automatic control system, and more particularly, to a PID closed-loop automatic control system for the main stream temperature of large boiler for a power plant.

2. Description of the Related Art

Main stream temperatures of boilers in current large power plant are mostly controlled by PID closed-loop automatic control systems employing cascade fixed parameters. Due to the characteristics of non-linearity, great inertia and large lag of the boilers in a large power plant, such traditional cascade closed-loop control systems cannot dynamically and quickly complete the regulation and control of main stream temperature of a boiler with respect to change in load of the large boiler, change in the amount of water supplied to the boiler, and changes during peak load regulation of the boiler power unit, causing the control performance of main stream temperature of the large boiler is deteriorated, even does not meet the requirements of control criteria, thereby directly affecting safe and economic operation of the boiler.

### SUMMARY

The control system for the main stream temperature of a large boiler provided by the present invention solves the technical problem that currently available closed-loop control systems cannot dynamically and rapidly complete the regulation and control of main stream temperature of a boiler with respect to change in load of the boiler, change in the amount of water supplied to the boiler, and changes during peak load regulation of the boiler power unit, whereby the performance of main stream temperature control of the large boiler is lowered.

The present invention solves the aforementioned problem by virtue of the following solutions.

A main stream temperature control system for a large boiler includes a power plant boiler, A/D converters, D/A converters, and main stream temperature sensors of the power plant boiler. A total fuel quantity instruction P₀ of a power unit in which the power plant boiler locates is connected to an input terminal i₁ of a feed-forward path module, an output terminal of a platen superheater outlet first main stream temperature sensor T1 of the power plant boiler is connected to an input terminal i₂ of a first A/D converter M2, an output terminal of a platen superheater outlet second main stream temperature sensor T2 is connected to an input terminal i₃ of a second A/D converter M3, an output terminal of a platen superheater inlet third main stream temperature sensor T3 is connected to an input terminal i₄ of a third A/D converter M4, an output terminal of a platen superheater inlet fourth main stream temperature sensor T4 is connected to an input terminal i₅ of a fourth A/D converter M5, a stream drum pressure signal Pb of the power unit in which the power plant boiler locates is connected to an input terminal i₆ of a stream enthalpy value correction module and simultaneously connected to an input terminal i₇ of an overheat protection module, an output terminal o₂ of the first A/D converter M2 is connected to an input terminal of a first either-or module N1, an output terminal o₃ of the second A/D converter M3 is connected to another input terminal of the first either-or module N1, an output terminal o₄ of the third A/D converter M4 is connected to an input terminal of a second either-or module N2, an output terminal o₅ of the fourth A/D converter M5 is connected to another input terminal of the second either-or module N2, an output terminal θ₂ of the first either-or module N1 is connected to a negative terminal of a first addition and subtraction module J1, an output terminal θ₃ of the second either-or module N2 is connected respectively to an input terminal of a differential module and an input terminal of the overheat protection module, an output terminal θ₂₀ of a platen superheater outlet stream temperature set value module is connected to a positive terminal of the first addition and subtraction module J1, an output terminal of the first addition and subtraction module J1 is connected to an input terminal x1 of a division module, an output terminal of the stream enthalpy value correction coefficient module is connected to another input terminal x2 of the division module, an output terminal x3 of the division module is connected to a positive input terminal of a second addition and subtraction module J2, an output terminal x4 of the feed-forward path module is connected to a negative input terminal of the second addition and subtraction module J2, an output terminal x5 of the differential module is connected to a positive input terminal of a third addition and subtraction module J3, an output terminal x6 of the second addition and subtraction module J2 is connected to a negative input terminal of the addition and subtraction module J3, an output terminal of the addition and subtraction module J3 is connected to an input terminal X7 of a first small value comparison module Z1, an output terminal of the overheat protection module is connected to an input terminal X8 of the first small value comparison module Z1, an output terminal of the first small value comparison module Z1 is connected to an input terminal X9 of a PID module in a boiler automatic control system, a main fuel trip instruction MFT is connected to an input terminal of a time pulse module S1, an output terminal of the time pulse module S1 is connected to a switch input terminal R1 of the PID module in the boiler automatic control system, an input terminal of a function module f(x) is connected to a power unit load N, an output terminal of the function module f(x) is connected to a p1 terminal of the PID module, an output terminal of the PID module in the boiler automatic control system is connected to an input terminal X21 of a multiplication module F1 and also connected to a positive input terminal X10 of an addition and subtraction module J4, an output terminal of a fifth set value module K5 is connected to another positive input terminal X11 of the fourth addition and subtraction module J4, an output terminal of a sixth set value module K6 is connected to a negative input terminal X12 of the fourth addition and subtraction module J4, an output terminal of a first set value module K1 is connected to an input terminal X13 of a first multiplication module F1, an output terminal of the first multiplication module F1 is connected to an input terminal X14 of a second small value comparison module Z2, an output terminal of a third set value module K3 is connected to another input terminal X15 of the second small value comparison module Z2, an output terminal of the second small value comparison module Z2 is connected to an input terminal X16 of a first D/A converter M6, an output terminal of the first D/A converter M6 is connected to a signal input terminal of a first electrical water spray adjusting valve AA101 of the power plant boiler, an output terminal of the fourth addition and subtraction module J4 is connected to an input terminal X17 of a second multiplication module F2, an output terminal of the second multiplication module F2 is connected to an input terminal X18 of a big value comparison module Z3, an output terminal of a fourth set value module K4 is connected to another input terminal X19 of the big value comparison module Z3, an output terminal of the big value comparison module Z3 is connected to an input terminal X20 of a second D/A converter M7, and an output terminal of the second D/A converter M7 is connected to a signal input terminal of a second electrical water spray adjusting valve AA102 of the power plant boiler.

The power plant boiler is a pulverized coal combustion boiler of 200 megawatts or more.

The present invention introduces various dynamic parameters that affect the temperature of the power plant boiler into the PID closed-loop control system for the main stream temperature of the power plant boiler, thereby dynamic tracking and stable control of the main stream temperature of the large boiler can be realized, thereby increasing the thermal economic index of the boiler, and achieving the objective of energy saving and emission reduction.

### BRIEF DESCRIPTION OF THE DRAWINGS

FIG. 1 is a schematic diagram illustrating the circuit configuration according to the present invention.

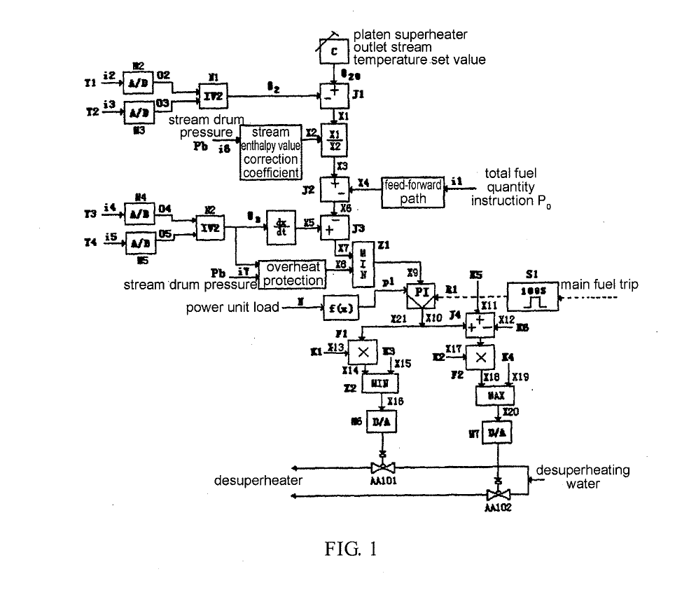

### DETAILED DESCRIPTION

A main stream temperature control system for a large boiler includes a power plant boiler, A/D converters, D/A converters, and main stream temperature sensors of the power plant boiler. A total fuel quantity instruction P₀ of a power unit in which the power plant boiler locates is connected to an input terminal i₁ of a feed-forward path module, an output terminal of a platen superheater outlet first main stream temperature sensor T1 of the power plant boiler is connected to an input terminal i₂ of a first A/D converter M2, an output terminal of a platen superheater outlet second main stream temperature sensor T2 is connected to an input terminal i₃ of a second A/D converter M3, an output terminal of a platen superheater inlet third main stream temperature sensor T3 is connected to an input terminal i₄ of a third A/D converter M4, an output terminal of a platen superheater inlet fourth main stream temperature sensor T4 is connected to an input terminal i₅ of a fourth A/D converter M5, a stream drum pressure signal Pb of the power unit in which the power plant boiler locates is connected to an input terminal i₆ of a stream enthalpy value correction module and simultaneously connected to an input terminal i₇ of an overheat protection module, an output terminal o₂ of the first A/D converter M2 is connected to an input terminal of a first either-or module N1, an output terminal o₃ of the second A/D converter M3 is connected to another input terminal of the first either-or module N1, an output terminal o₄ of the third A/D converter M4 is connected to an input terminal of a second either-or module N2, an output terminal o₅ of the fourth A/D converter M5 is connected to another input terminal of the second either-or module N2, an output terminal θ₂ of the first either-or module N1 is connected to a negative terminal of a first addition and subtraction module J1, an output terminal θ₃ of the second either-or module N2 is connected respectively to an input terminal of a differential module and an input terminal of the overheat protection module, an output terminal θ₂₀ of a platen superheater outlet stream temperature set value module is connected to a positive terminal of the first addition and subtraction module J1, an output terminal of the first addition and subtraction module J1 is connected to an input terminal x1 of a division module, an output terminal of the stream enthalpy value correction coefficient module is connected to another input terminal x2 of the division module, an output terminal x3 of the division module is connected to a positive input terminal of a second addition and subtraction module J2, an output terminal x4 of the feed-forward path module is connected to a negative input terminal of the second addition and subtraction module J2, an output terminal x5 of the differential module is connected to a positive input terminal of a third addition and subtraction module J3, an output terminal x6 of the second addition and subtraction module J2 is connected to a negative input terminal of the addition and subtraction module J3, an output terminal of the addition and subtraction module J3 is connected to an input terminal X7 of a first small value comparison module Z1, an output terminal of the overheat protection module is connected to an input terminal X8 of the first small value comparison module Z1, an output terminal of the first small value comparison module Z1 is connected to an input terminal X9 of a PID module in a boiler automatic control system, a main fuel trip instruction MFT is connected to an input terminal of a time pulse module S1, an output terminal of the time pulse module S1 is connected to a switch input terminal R1 of the PID module in the boiler automatic control system, an input terminal of a function module f(x) is connected to a power unit load N, an output terminal of the function module f(x) is connected to a p1 terminal of the PID module, an output terminal of the PID module in the boiler automatic control system is connected to an input terminal X21 of a multiplication module F1 and also connected to a positive input terminal X10 of an addition and subtraction module J4, an output terminal of a fifth set value module K5 is connected to another positive input terminal X11 of the fourth addition and subtraction module J4, an output terminal of a sixth set value module K6 is connected to a negative input terminal X12 of the fourth addition and subtraction module J4, an output terminal of a first set value module K1 is connected to an input terminal X13 of a first multiplication module F1, an output terminal of the first multiplication module F1 is connected to an input terminal X14 of a second small value comparison module Z2, an output terminal of a third set value module K3 is connected to another input terminal X15 of the second small value comparison module Z2, an output terminal of the second small value comparison module Z2 is connected to an input terminal X16 of a first D/A converter M6, an output terminal of the first D/A converter M6 is connected to a signal input terminal of a first electrical water spray adjusting valve AA101 of the power plant boiler, an output terminal of the fourth addition and subtraction module J4 is connected to an input terminal X17 of a second multiplication module F2, an output terminal of the second multiplication module F2 is connected to an input terminal X18 of a big value comparison module Z3, an output terminal of a fourth set value module K4 is connected to another input terminal X19 of the big value comparison module Z3, an output terminal of the big value comparison module Z3 is connected to an input terminal X20 of a second D/A converter M7, and an output terminal of the second D/A converter M7 is connected to a signal input terminal of a second electrical water spray adjusting valve AA102 of the power plant boiler. The power plant boiler is a pulverized coal combustion boiler of 200 megawatts or more.

What is claimed is:

1. A main stream temperature control system for a large boiler comprises a power plant boiler, A/D converters, D/A converters, and main stream temperature sensors of the power plant boiler. A total fuel quantity instruction P₀ of a power unit in which the power plant boiler locates is connected to an input terminal of a feed-forward path module, an output terminal of a platen superheater outlet first main stream temperature sensor T1 of the power plant boiler is connected to an input terminal i₂ of a first A/D converter M2, an output terminal of a platen superheater outlet second main stream temperature sensor T2 is connected to an input terminal i₃ of a second A/D converter M3, an output terminal of a platen superheater inlet third main stream temperature sensor T3 is connected to an input terminal i₄ of a third A/D converter M4, an output terminal of a platen superheater inlet fourth main stream temperature sensor T4 is connected to an input terminal i₅ of a fourth A/D converter M5, a stream drum pressure signal Pb of the power unit in which the power plant boiler locates is connected to an input terminal i₆ of a stream enthalpy value correction module and simultaneously connected to an input terminal i₇ of an overheat protection module, an output terminal o₂ of the first A/D converter M2 is connected to an input terminal of a first either-or module N1, an output terminal o₃ of the second A/D converter M3 is connected to another input terminal of the first either-or module N1, an output terminal o₄ of the third A/D converter M4 is connected to an input terminal of a second either-or module N2, an output terminal o₅ of the fourth A/D converter M5 is connected to another input terminal of the second either-or module N2, an output terminal θ₂ of the first either-or module N1 is connected to a negative terminal of a first addition and subtraction module J1, an output terminal θ₃ of the second either-or module N2 is connected respectively to an input terminal of a differential module and an input terminal of the overheat protection module, an output terminal θ₂₀ of a platen superheater outlet stream temperature set value module is connected to a positive terminal of the first addition and subtraction module J1, an output terminal of the first addition and subtraction module J1 is connected to an input terminal x1 of a division module, an output terminal of the stream enthalpy value correction coefficient module is connected to another input terminal x2 of the division module, an output terminal x3 of the division module is connected to a positive input terminal of a second addition and subtraction module J2, an output terminal x4 of the feed-forward path module is connected to a negative input terminal of the second addition and subtraction module J2, an output terminal x5 of the differential module is connected to a positive input terminal of a third addition and subtraction module J3, an output terminal x6 of the second addition and subtraction module J2 is connected to a negative input terminal of the addition and subtraction module J3, an output terminal of the addition and subtraction module J3 is connected to an input terminal X7 of a first small value comparison module Z1, an output terminal of the overheat protection module is connected to an input terminal X8 of the first small value comparison module Z1, an output terminal of the first small value comparison module Z1 is connected to an input terminal X9 of a PID module in a boiler automatic control system, a main fuel trip instruction MFT is connected to an input terminal of a time pulse module S1, an output terminal of the time pulse module S1 is connected to a switch input terminal R1 of the PID module in the boiler automatic control system, an input terminal of a function module f(x) is connected to a power unit load N, an output terminal of the function module f(x) is connected to a p1 terminal of the PID module, an output terminal of the PID module in the boiler automatic control system is connected to an input terminal X21 of a multiplication module F1 and also connected to a positive input terminal X10 of an addition and subtraction module J4, an output terminal of a fifth set value module K5 is connected to another positive input terminal X11 of the fourth addition and subtraction module J4, an output terminal of a sixth set value module K6 is connected to a negative input terminal X12 of the fourth addition and subtraction module J4, an output terminal of a first set value module K1 is connected to an input terminal X13 of a first multiplication module F1, an output terminal of the first multiplication module F1 is connected to an input terminal X14 of a second small value comparison module Z2, an output terminal of a third set value module K3 is connected to another input terminal X15 of the second small value comparison module Z2, an output terminal of the second small value comparison module Z2 is connected to an input terminal X16 of a first D/A converter M6, an output terminal of the first D/A converter M6 is connected to a signal input terminal of a first electrical water spray adjusting valve AA101 of the power plant boiler, an output terminal of the fourth addition and subtraction module J4 is connected to an input terminal X17 of a second multiplication module F2, an output terminal of the second multiplication module F2 is connected to an input terminal X18 of a big value comparison module Z3, an output terminal of a fourth set value module K4 is connected to another input terminal X19 of the big value comparison module Z3, an output terminal of the big value comparison module Z3 is connected to an input terminal X20 of a second D/A converter M7, and an output terminal of the second D/A converter M7 is connected to a signal input terminal of a second electrical water spray adjusting valve AA102 of the power plant boiler.

2. The main stream temperature control system for a large boiler according to claim 1, characterized in that the power plant boiler is a pulverized coal combustion boiler of 200 megawatts or more.
